(19) United States
(12) Patent Application Publication
(10) Pub. No.: US 2010/0053513 A1
(43) Pub. Date: Mar. 4, 2010

(54) Method of Manufacturing a Display Substrate, a Display Substrate Manufactured According to the Method, and a Method for Manufacturing a Display Device Having the Display Substrate

(76) Inventors: Soon-Joon Rho, Suwon-si (KR); Baek-Kyun Jeon, Yongin-si (KR); Hee-Keun Lee, Suwon-si (KR); Hong-Koo Baik, Seoul (KR); Youn-Sang Kim, Goyang-si (KR); Jong-Bok Kim, Seoul (KR); Byoung-Har Hwang, Goyang-si (KR); Chu-Ji Choi, Seoul (KR); Min-Jung Lee, Seoul (KR)

Correspondence Address: F. CHAU & ASSOCIATES, LLC, 130 WOODBURY ROAD, WOODBURY, NY, 11797, US

(21) Appl. No.: 12/496,409

(22) Filed: Jul. 1, 2009

(30) Foreign Application Priority Data
Aug. 26, 2008 (KR) 2008-83140

(51) Int. Cl. G02F 1/1335; B05D 5/12; B05D 3/06

(52) U.S. Cl. 349/106; 427/66; 427/553

(57) ABSTRACT

In a method of manufacturing a display substrate, a color filter is formed on a first substrate including a switching element. A pixel electrode is formed on the first substrate including the color filter. An inorganic alignment layer including an inorganic compound is formed on the first substrate including the pixel electrode. Thus, impurities generated from the color filter may be blocked from flowing into a liquid crystal layer, and liquid crystal molecules of the liquid crystal layer may be aligned by the inorganic layer.

### CROSS-REFERENCE TO RELATED APPLICATION

This application claims priority under 35 U.S.C. §119 to Korean Patent Application No. 10-2008-0083140, filed on Aug. 26, 2008 in the Korean Intellectual Property Office (KIPO), the contents of which are herein incorporated by reference in their entirety.

### BACKGROUND OF THE INVENTION

1. Technical Field

The present invention relates to a display substrate and more particularly, to a method of manufacturing a display substrate, a display substrate manufactured according to the method, and a method for manufacturing a display device having the display substrate.

2. Discussion of the Related Art

Generally, a liquid crystal display (LCD) panel includes a matrix of pixels and a display substrate having a switching element to drive each pixel. An opposite substrate faces the display substrate and including a color filter and a liquid crystal layer disposed between the display substrate and the opposite substrate. An image is display ed on the LCD panel according to the light transmittance of liquid crystal material, which varies according to a voltage applied thereto.

In a method of manufacturing the display substrate, a signal line transmitting a signal and a thin-film transistor (TFT) that is the switching element connected to the signal line are formed on a base substrate, and a pixel electrode is formed on the base substrate having the signal line and the TFT. An alignment layer is formed on the base substrate having the pixel electrode. The alignment layer may be generally formed using a polyimide organic material.

In order to prevent the display quality of the display device from deteriorating during the manufacturing process as a result of a misalignment between the display substrate and the opposite substrate, and in order to simplify a method of manufacturing a display panel, the display substrate may include a color filter. For example, the color filter may be formed between the TFT and the pixel electrode. The display substrate may further include an organic layer formed on the color filter and the pixel electrode. The organic layer may planarize the display substrate having the color filter and protect the color filter during a process of forming the pixel electrode. The organic layer may block impurities from flowing into the liquid crystal layer through the pixel electrode and the alignment layer. The impurities may be an organic compound forming the color filter. The impurities may be particles or gases.

Recently, a display substrate which includes a thick color filter without the organic layer has been developed. A method of manufacturing the display substrate may be simplified and the manufacturing costs may be decreased by omitting the organic layer. The yield of the display substrate is increased by omitting the organic layer.

However, the liquid crystal layer may be contaminated by impurities flowing into the liquid crystal layer through the pixel electrode and the alignment layer, and thus the display quality may deteriorate during the manufacturing process to the point where afterimages are generated when the resulting display panel having the display substrate is used to display an image. In particular, impurities such as organic materials may penetrate through the alignment layer and contaminate the liquid crystal layer.

### SUMMARY OF THE INVENTION

Exemplary embodiments of the present invention provide a method of manufacturing a display substrate, the method being capable of improving productivity and display quality by preventing the inflow of impurities generated from a color filter into a liquid crystal layer.

Exemplary embodiments of the present invention also provide a method of manufacturing a display device having the display substrate.

Exemplary embodiments of the present invention also provide a display substrate capable of improving the reliability of a manufacturing method.

According to one aspect of the present invention, there is provided a method of manufacturing a display substrate. In the method, a color filter is formed on a first substrate including a switching element. A pixel electrode is formed on the first substrate including the color filter. An inorganic alignment layer including an inorganic compound is formed on the first substrate including the pixel electrode.

According to an exemplary embodiment of the present invention, a coating layer may be formed bid first coating the inorganic alignment layer, and then the inorganic compound of the inorganic alignment layer may react with the coating layer to form an inorganic layer.

According to an exemplary embodiment of the present invention, the coating layer may be formed by a roller coating method, a spin-coating method, a jetting method or a dipping method and may coat the inorganic alignment layer.

According to an exemplary embodiment of the present invention, the inorganic compound of the inorganic alignment layer may include an organosilicon compound, and the inorganic layer may include silicon oxide (SiOₓ, (0<x≦1). The organosilicon compound may include polydimethylsiloxane (PDMS).

According to some exemplar embodiments of the present invention, the organosilicon compound may include one or more of tetraethoxysilane (TEOS), methyltriethoxysilane (MTES), etc. The organosilicon compound of a sol state may form the coating layer, and the organosilicon compound may react to form the inorganic layer including the organosilicon of a gel state.

According to an exemplary embodiment of the present invention, there is provided a method of manufacturing a display apparatus. In forming a displays substrate, an inorganic alignment layer is coated on a first substrate to form a first inorganic layer including an inorganic compound. The first substrate includes a switching element, a color filter and a pixel electrode. In forming an opposite substrate, the inorganic alignment layer is coated on a second substrate to form a second inorganic layer. The second substrate faces the first substrate. The display substrate and the opposite substrate are assembled to the display apparatus.

According to an exemplary embodiment of the present invention, a display substrate includes a switching element, a color filter formed on the switching element, a color filter formed on the first substrate including the switching element, a pixel electrode connected to the switching element and formed on the color filter, and an inorganic layer formed on the first substrate including the pixel electrode.

According to an exemplary embodiment of the present invention, a display substrate includes a switching element formed on a first substrate, a color filter formed on the first substrate including the switching element, a pixel electrode connected to the switching element and formed on the color filter, and an alignment layer formed on the first substrate including the pixel electrode. The alignment layer is inclined relative to a surface of the first substrate.

In accordance with one or more exemplary embodiments of the present disclosure, an inorganic layer that vertically aligns liquid crystal molecules is formed on a color filter, and thus impurities generated from the color filter may not flow into a liquid crystal layer. Thus, the display quality may be improved.

Moreover, a capping layer blocking the impurities may be omitted by forming the inorganic layer, and thus manufacturing costs map be decreased and the productivity may be improved.

In particular, a step of forming the inorganic layer may be easily performed by a coating process under non-vacuum conditions that does not require an expensive apparatus maintaining vacuum conditions, and thus the productivity may be improved.

### BRIEF DESCRIPTION OF THE DRAWINGS

The above and other features and aspects of exemplary embodiments of the present invention will be described in detailed below with reference to the accompanying drawings.

FIG. 1 is a plan view illustrating a display device in accordance with an exemplary embodiment of the present invention;

FIG. 2 is a cross-sectional view taken along a line I-I′ shown in FIG. 1;

FIGS. 3A to 3E are cross-sectional views illustrating a method of manufacturing the display substrate shown in FIG. 2;

FIGS. 4 and 5 are cross-sectional views illustrating a method of manufacturing the display substrate shown in FIG. 2;

FIGS. 6A to 6F and 7A to 7C are cross-sectional, perspective and plan views illustrating a method of manufacturing a display device in accordance with an exemplary embodiment of the present invention;

FIG. 8 is a cross-sectional view illustrating a displays device in accordance with an exemplar embodiment of the present invention;

FIGS. 9A and 9B are cross-sectional views illustrating a method of manufacturing the display substrate shown in FIG. 8;

FIG. 10 is a plan view illustrating a display device in accordance with an exemplary embodiment of the present invention;

FIG. 11 is a cross-sectional view taken along a line II-II′ shown in FIG. 10;

FIGS. 12A to 12C, FIGS. 13A and 13B, and FIGS. 14A to 14C are cross-sectional views illustrating a method of manufacturing the display substrate shown in FIG. 10;

FIG. 15A is an image showing a polarized optical microscope image of a coating layer in accordance with an exemplary embodiment of the present invention;

FIG. 15B is an image showing a polarized optical microscope image of an inorganic layer in accordance with an exemplary embodiment of the present invention; and

FIG. 16 is a graph illustrating transmittance according to a driving voltage and which represents alignment characteristics of the inorganic layer in accordance with an exemplary embodiment of the present invention.

### DETAILED DESCRIPTION OF THE EXEMPLARY EMBODIMENTS

Exemplary embodiments of the present invention are described more fully hereinafter with reference to the accompanying drawings. The present invention may, however, be embodied in many different forms and should not be construed as limited to the exemplary embodiments set forth herein. Rather, these exemplary embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present.

Exemplary embodiments of the invention are described herein with reference to cross-sectional illustrations that may be schematic illustrations of idealized exemplary embodiments (and intermediate structures) of the present invention. As such, variations from the shapes of the illustrations as a result, for example, of manufacturing techniques and/or tolerances are contemplated. Thus, exemplary embodiments of the present invention should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes might not be intended to illustrate the actual shape of a region of a device and are not intended to limit the scope of the present invention.

Hereinafter, the present invention will be explained in detail with reference to the accompanying drawings.

Hereinafter, in the description and the claims, a coating layer may define a layer which is formed on a substrate and may be formed by coating an inorganic alignment layer under non-vacuum conditions. An inorganic layer may define a layer which extends perpendicularly to a surface of the substrate and aligns liquid crystal molecules in a direction based on the surface of the substrate. Moreover, an alignment laser may define a layer which is inclined to have an inclination of less than about 90°. The liquid crystal molecules are vertically arranged by the alignment layer. The liquid crystal molecules have a pretilt angle due to the alignment layer. The liquid crystal molecules are divided be the alignment layer to form a plurality or domains.

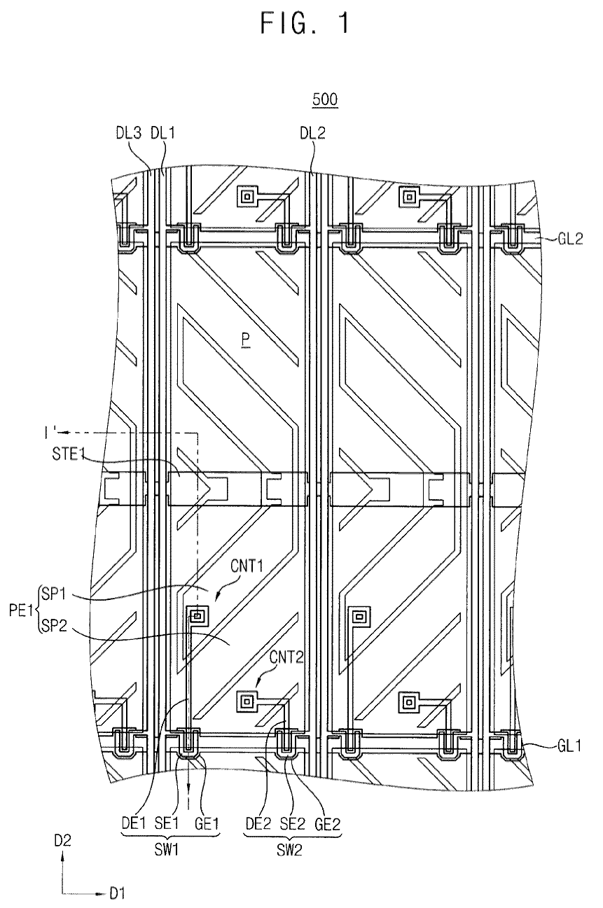

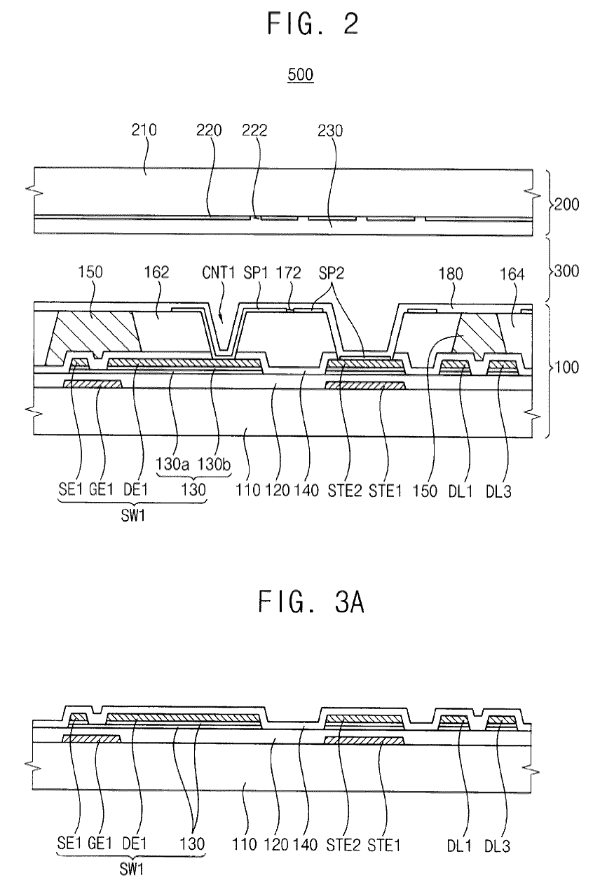

FIG. 1 is a plan view illustrating a display device in accordance with an exemplary embodiment of the present invention, and FIG. 2 is a cross-sectional view taken along a line I-I′ shown in FIG. 1.

Referring to FIGS. 1 and 2, a first display device 500 in accordance with an exemplary embodiment of the present invention, includes a first display substrate 100, a first opposite substrate 200 facing the first display substrate 100, and a liquid crystal layer 300 interposed between the first display substrate 100 and the first opposite substrate 200.

The first display substrate 100 includes a first substrate 110 and a plurality of gate lines GL1 and GL2 formed on the first substrate 110, a plurality of data lines DL1, DL2 and DL3, a plurality of thin-film transistors (TFTs) SW1 and SW2, a plurality of storage electrodes STE1 and STE2, a black matrix pattern 150, a plurality of color filters 162 and 164, a first pixel electrode PE1, and a first inorganic layer 180, which are formed on a first substrate 110. The gate lines GL1 and GL2 and the data lines DL1, DL2 and DL3 cross each other to define one pixel P.

The gate lines GL1 and GL2 may extend in a first direction D1 of the first substrate 110. The gate lines GL1 and GL2 may be disposed in parallel in a second direction D2 different from the first direction D1. For example, the first direction D1 may be perpendicular to the second direction D2. For example, based on a first gate line GL1, a second gate line GL2 adjacent to the first gate line GL1 may be disposed in the second direction D2 of the first gate line GL1.

The first display substrate 100 may further include a gate insulation layer 120. The gate insulation layer 120 may be formed on the first substrate 110 including the first gate line GL1 and the second gate line GL2.

The data lines DL1, DL2 and DL3 may extend in the second direction D2 and may run parallel to each other. The first data line DL1 and the second data line DL2 may define a long side of the pixel P.

One or more of the TFTs SW1 and SW2 may be formed on the pixel P. The TFTs SW1 and SW2 may include a first TFT SW1 and a second TFT SW2 which divide the pixel P into two areas and drive each of the two areas. The first TFT SW1 may be electrically connected to the first gate line GL1 and the first data line DL1. The second TFT SW2 may be electrically connected to the first gate line GL1 and the second data line DL2.

The first TFT SW1 may include a first gate electrode GE1 connected to the first gate line GL1, a first source electrode SE1 connected to the first data line DL1, a first drain electrode DE1 spaced apart from the first source electrode SE1, and an active pattern 130 formed on the gate insulation layer 120. The active pattern 130 may include a semiconductor layer 130a and an ohmic contact layer 130b formed on the semiconductor layer 130a, The second TFT SW2 may include a second gate electrode GE2 connected to the first gate line GL1, a second source electrode SE2 connected to the second date line DL2, a second drain electrode DE2 spaced apart from the second source electrode SE2. Not shown in the figures, the second TFT SW2 may further include the active pattern 130 formed on the gate insulation layer 120 which is formed on the second gate electrode DE2.

The storage electrodes STE1 and STE2 may include a first storage electrode STE1, which is formed on the first substrate 110, and a second storage electrode STE2, which is formed on the first storage electrode STE1. A plurality of the first storage electrodes STE1 may be connected to each other. The first storage electrode STE1 and the second storage electrode STE2 may include a storage capacitor (Cst) with a dielectric substance interposed between the first storage electrode STE1 and the second storage electrode STE2. For example, the dielectric substance may include the gate insulation layer 120, the semiconductor layer 130a and the ohmic contact layer 130b.

The first display substrate 100 may further include a passivation layer 140. The passivation layer 140 may be formed on the first substrate 110 including the first, second and third data lines DL1, DL2 and DL3.

The black matrix pattern 150 may be formed on the passivation layer 140 which is formed on the first and second gate lines GL1 and GL2, the first and second TFTs SW1 and SW2, the first, second and third data lines DL1, DL2 and DL3. The black matrix pattern 150 may block light provided to the liquid crystal layer 300. The light may be received from under the first display substrate 100.

Each of the color filters 162 and 164 may be formed on the passivation layer 140 of each pixel P. The color filters 162 and 164 may include a first color filter 162, a second color filter 164 and a third color filter (not shown). The first color filter 162 and the second color filter 164 may each represent different colors. For example, the first color filter 162 may represent red, and the second color filter 164 may represent blue.

The first color filter 162 may include a storage hole formed by removing a portion of the first color filter 162, the portion corresponding to an area including the second storage electrode STE2. The second storage electrode STE2 may contact the first pixel electrode PE1 through the storage hole, and thus the first pixel electrode PE1 may be electrically connected to the second storage electrode STE2.

Although not shown in the figures, in some exemplary embodiments, the black matrix pattern 150 may be omitted and the job of the black matrix may be performed by overlapping the first color filter 162 with the second color filter 164 at a boundary between the first pixel electrodes PE1 adjacent to each other. In particular, an overlapped area between the first color filter 162 and the second color filter 164 may include areas which are the first and second gate lines GL1 and GL2 and the first, second and third data line DL1, DL2 and DL3. The overlapped area between the first color filter 162 and the second color filter 164 may include areas which are the first and second TFTs SW1 and SW2.

A first pixel electrode PE1 may be formed on the first color filter 162. The first pixel electrode PE1 may include a first sub-electrode SP1 and a second sub-electrode SP2 separated from the first sub-electrode SP1.

The first sub-electrode SP1 may be electrically connected to the first TFT SW1 through a first contact hole CNT1. The first contact hole CNT1 may be formed on the first drain electrode DE1 to expose a portion of the first drain electrode DE1. The first contact hole CNT1 may be formed in the passivation layer 140 and the first color filter 162. The second sub-electrode SP2 may be electrically connected to the second TFT SW2 through a second contact hole CNT2. For example, the second sub-electrode SP2 may be formed around the first sub-electrode SP1. The second contact hole CNT2 may be formed on the second drain electrode DE2 to expose a portion of the second drain electrode DE2.

According to an exemplary embodiment, the first sub-electrode SP1 may receive a first pixel voltage from the first TFT SW1. The first pixel voltage which is received from the first data line DL1 may correspond to a first gate voltage which is received from the first gate line GL1. The second sub-electrode SP2 may receive a second pixel voltage from the second TFT SW2. The second pixel voltage which is received from the second line DL2 may correspond to a second gate voltage which is received from the first gate line GL1.

The transmittance of the liquid crystal molecules in each of an area having the first subelectrode SP1 and an area having the second sub-electrode SP2 may be individually controlled to increase the viewing angle.

The first sub-electrode SP1 and the second electrode SP2 which is spaced apart from the first sub-electrode SP1 may define a first opening pattern 172 of the first pixel electrode PE1. The first opening pattern 172 may change the flow of an electric field in the liquid crystal layer 300 to increase the viewing angle.

The first inorganic layer 180 may be formed on the first substrate 110 including the first pixel electrode PE1. The first inorganic layer 180 may extend in a direction perpendicular to a surface of the first substrate 110. The first inorganic layer 180 may be formed on the entire surface of the first substrate 110 having the first pixel electrode PE1. According to an exemplary embodiment of the present invention, the first inorganic layer 180 may contact the black matrix pattern 150, the first and second color filters 162 and 164, and the first pixel electrode PE1. For example, the first inorganic layer 180 may include a thickness of about 1.000 Å.

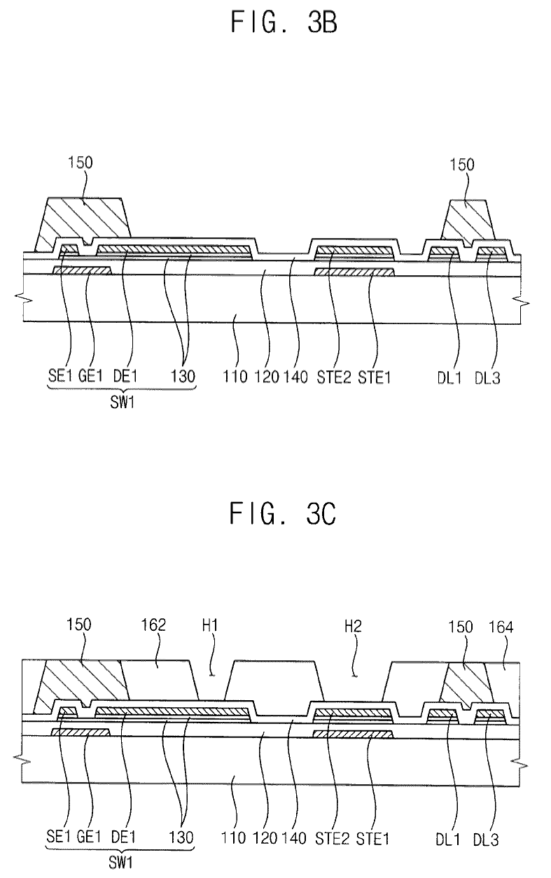

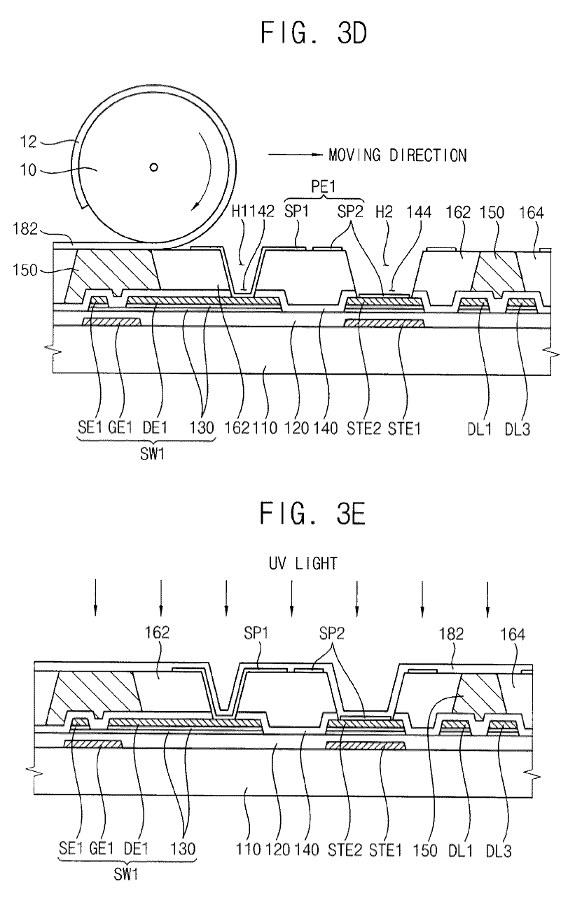

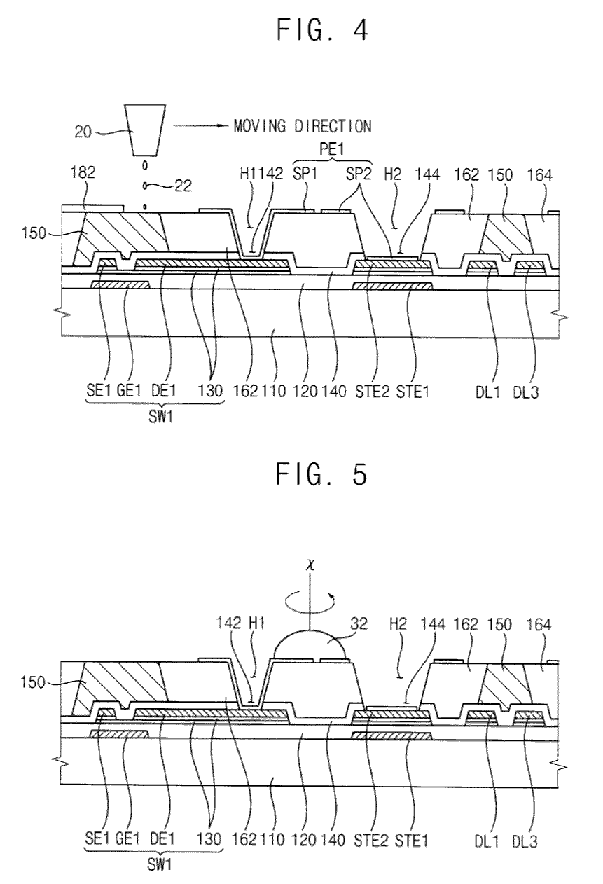

The first inorganic layer 180 may include silicon oxide (SiOₓ, 0<x≦1). The first inorganic layer 180 may be formed using an organosilicon compound in place of an inorganic compound. The first inorganic layer 180 may be formed by coating the organosilicon compound under non-vacuum conditions. For example, the first inorganic layer 180 may be formed by a roller coating method, a spin-coating method, a jetting method or a dipping method. Moreover, the first inorganic layer 180 may be formed by chemical vapor deposition (CVD) process. A process for forming the first inorganic layer 180 is discussed below with reference to FIG. 3D. FIG. 3E, FIG. 4, and FIG. 5.

In forming the first display substrate 100, materials forming the black matrix pattern 150 and the first and second color filters 162 and 164 may be partially vaporized producing impurities. For example, the impurities may include organic materials. The first inorganic layer 180 may block the impurities from flowing into the first inorganic layer 180, and thus the first inorganic layer 180 may block the impurities from flowing into the liquid crystal layer 300. Moreover, the first inorganic layer 180 may extend perpendicularly to the surface of the first substrate 110, and thus the first inorganic layer 180 may vertically align the liquid crystal molecules of the liquid crystal layer 300.

The first inorganic layer 180 may be formed on the first substrate 110, and thus a capping layer for blocking the impurities and an alignment layer for vertical alignment may be omitted, and the job of blocking the impurities and performing vertical alignment may be performed by the first inorganic laser 180. Thus, a process of manufacturing the first display substrate 100 may be simplified and the productivity may be improved.

The first opposite substrate 200 may include a second substrate 210, a common electrode layer 220 and a second inorganic layer 230.

The common electrode layer 220 may be formed on the second substrate 210. The common electrode layer 220 may include a second opening pattern 222 which exposes the second substrate 210. The second opening pattern 222 may cross the first opening pattern 172. The second opening pattern 222 may change the flow of the electric, field in the liquid crystal layer 300 with the first opening pattern 172.

The second inorganic layer 230 may be formed on the common electrode layer 220. The second inorganic layer 230 may extend in a direction perpendicular to the surface of the second substrate 210. For example, the second inorganic layer 230 may include silicon oxide. The second inorganic layer 230 may vertically align the liquid crystal molecules of the liquid crystal layer 300. The second inorganic layer 230 may be substantially the same as the first inorganic layer 180 described above, except the second inorganic layer 230 is formed on the second substrate 210. Thus, repetitive descriptions will be omitted.

The liquid crystal layer 300 may be formed between the first display substrate 100 and the first opposite substrate 200. According to an exemplary embodiment, the liquid crystal layer 300 may include liquid crystal molecules of a negative type having a negative dielectric anisotropy. A cell gap of the liquid crystal layer 300 may be about 1.0 μm to about 4.0 μm. The cell gap may be defined by a distance between the first display substrate 100 and the first opposite substrate 200.

When the electric field is not formed in the liquid crystal layer 300, the liquid crystal molecules may be vertically aligned by the first inorganic layer 180 and the second inorganic layer 230, based on the surface of the first display substrate 100.

FIGS. 3A to 3E are cross-sectional views illustrating a method of manufacturing the display substrate shown in FIG. 2.

Referring to FIG. 3A, a gate metal layer (not shown) may be formed on the first substrate 110, and the gate metal layer may be patterned to form the first and second gate lines GL1 and GL2, the first and second gate electrodes GE1 and GE2 and the first storage electrode STE1. The gate metal layer may be patterned by a photolithography process.

The first substrate 110 may be formed using transparent glass or plastic.

The gate insulation layer 120 may be formed on the first substrate 110 having the first and second gate lines GL1 and GL2, the first and second gate electrodes GE1 and GE2, and the first storage electrode STE1. For example, the gate insulation layer 120 may be formed by plasma-enhanced chemical vapor deposition (PECVD) using silicon nitride under vacuum conditions.

The semiconductor layer 130a, the ohmic contact layer 130b and a data metal layer (not shown) may be formed on the first substrate 110 having the gate insulation layer 120. For example, the semiconductor layer 130a may include amorphous silicon, and the ohmic contact layer 130b may include amorphous silicon doped with n-type dopants at a high concentration (“n+a-Si”).

An etching mask (not shown) may be disposed on the first substrate 110 having the data metal layer. The data metal layer, the ohmic contact layer 130b and the semiconductor layer 130a may be patterned by a photolithography process using the etching mask. Thus the active pattern 130, the first, second and third data lines DL1, DL2 and DL3, the first source electrode SE1, the first drain electrode DE1 and the second storage electrode STE2.

In some exemplary embodiments, the active pattern 130 may be formed on the first substrate 110 having the gate insulation layer 120. The data metal layer may be formed on the first substrate 110 having the active pattern 130, and the data metal layer may be patterned to form the first, second and third data lines DL1, DL2 and DL3, the first source electrode SE1, the first drain electrode DE1 and the second storage electrode STE2.

The passivation layer 140 may be formed on the first substrate 110 having the first, second and third data lines DL1, DL2 and DL3, the first source electrode SE1, the first drain electrode DE1 and the second storage electrode STE2. For example, the passivation layer 140 may be formed by a PECVD process using silicon nitride.

Referring to FIG. 3B, the black matrix pattern 150 may be formed on the first substrate 110 having the passivation layer 140.

According to an exemplary embodiment, the black matrix pattern 150 may be formed by printing an organic material including an opaque pigment t. The black matrix pattern 150 may be formed by rolling the organic material using a roller or jetting the organic materials using a printer.

According to an exemplary embodiment, the black matrix 150 may be formed by exposing and developing an organic layer (not shown) including a pigment and a photosensitive compound, the organic layer being formed on the first substrate 110 having the passivation layer 140.

Referring to FIG. 3C, the first color filter 162 may be formed on the first substrate 110 having the black matrix pattern 150.

A first color photoresist layer (not shown) may be formed on the first substrate 110 having the black matrix pattern 150, and the first color photoresist layer may be patterned by a photolithography process to form the first color filter 162. The first color filter 162 may include a first hole H1 exposing the passivation layer 140 on the first drain electrode DE1, and a second hole H2 exposing the passivation layer 140 on the second storage electrode STE2.

According to an exemplary embodiment, the first color filter 162 may be formed by jetting or otherwise applying an organic ink including a pigment representing a first color on the first substrate 110 having the passivation laser 140. The first color filler 162 may be formed using self-emitting materials.

Referring to FIG. 3D, the second color filter 164 and the third color filter may be formed on the first substrate 110 having the first color filter 162. Steps of forming the second color filter 164 and the third color filter include substantially the same steps of forming the first color filter 162. Thus, repetitive descriptions will be omitted.

The passivation layer 140 may be patterned using the first color filter 162 as an etching mask. Thus, a third hole H3, which exposes the first drain electrode DE1 and corresponds to the first hole H1, may be formed in the passivation layer 140. A fourth hole H4, which exposes the second storage electrode STE2 and corresponds to the second hole H2, may be formed in the passivation layer 140.

A transparent electrode layer (not shown) may be formed on the first substrate 110 having the first (162), second (164) and third (not shown) color filters. Examples of a material that may be used for the transparent electrode layer may include indium tin oxide (ITO), indium zinc oxide (IZO), aluminum zinc oxide (AZO), etc.

The transparent electrode layer may be patterned to form the first pixel electrode PE1 including the first sub-electrode SP1 and the second sub-electrode SP2. The first pixel electrode PE1 may contact the first drain electrode DE1 through the first contact hole CNT1 including the first hole H1 and the second hole 142. The first pixel electrode PE1 may contact the second storage electrode STE2 through the second hole H2 and the fourth hole H4.

A first coating layer 182 may be formed on the first substrate 110 having the first pixel electrode PE1 by coating an inorganic alignment layer 12.

The inorganic alignment layer 12 may be applied to an outside of a roller 10. The roller 10 may be rolled in a direction on the first substrate 110 having the first pixel electrode PE1 to form the first coating layer 182. The first coating layer 182 may be formed under non-vacuum conditions. The non-vacuum conditions may include conditions which are opposite to the concept of vacuum conditions under excessively low pressure, and the non-vacuum conditions may have a pressure of no less than about 0.001 mmHg. The non-vacuum conditions of the present invention may include normal atmospheric pressure.

The inorganic alignment layer 12 may include an organosilicon compound.

According to an exemplary embodiment, the inorganic alignment layer 12 may include the organosilicon compound and a solvent dispersing the organosilicon compound. For example, the organosilicon compound may include polydimethylsiloxane (PDMS), and the solvent may include toluene.

Referring to FIG. 3E, the first inorganic layer 180 may be formed by exposing the first substrate 110 having the first coating layer 182 to light. For example, the light may include ultraviolet (UV) light. When the first coating layer 182 is exposed to the UV light, the first coating layer 182 may further receive oxygen. For example, the energy of the UV light which is exposed to the first coating layer 182 may be about 20 mJ to about 140 mJ. The UV light that is exposed to the first coating layer 182 may have a wavelength of about 150 nm to about 250 nm. For example, wavelength of the UV light may be about 200 nm.

For example, PDMS may receive the UV light and oxygen to form silicon oxide (SiOₓ, 0<x≦1). 1he first inorganic layer may include silicon oxide. A mechanism for the inorganic alignment layer 12 of the first coating layer 182 to form the first inorganic layer 180 is represented by, the following Reaction Formula 1. In the Reaction Formula 1, PDMS may not have directionality, and the silicon oxide may be extended in a perpendicular direction with respect to the surface of the first substrate 110. For example, the silicon oxide may have a directionality of about 90° based on the first substrate 110.

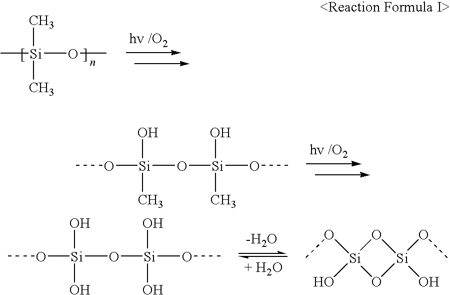

Although not shown in figures, the first coating layer 182 may be formed by a dipping method. For example, the first substrate 110 having the first pixel electrode PE1 may be dipped in a container including the inorganic alignment layer 12 to form the first coating layer 182 on the first substrate 110 having the first pixel electrode PE1.

According to some exemplary embodiments, the inorganic alignment layer 12 may include an organosilicon compound of a sol state. The inorganic alignment layer 12 may further include a solvent dispersing the organosilicon compound. Examples of a material that may be used for the organosilicon compound may include tetraethoxysilane (TEOS), methyl triethoxysilane (MTES), etc. For example, the solvent may include toluene.

For example, TEOS may be applied to the outside of the roller 10. The roller 10 may be rolled on the first substrate 110 having the first pixel electrode PE1 to form the first coating layer 182. As the solvent of the inorganic alignment latter 12 is removed. TEOS may transition to a gel state having a net shape according to a hydrolysis and/or a condensation reaction, and thus TEOS mar be continually polymerized to become an oligomer. Thus, the first inorganic layer 180 may include the oligomer. In forming the first inorganic layer 180, water may be further provided for the first coating layer 182 to generate the hydrolysis and/or the condensation reaction.

The method of the first display substrate 110 may further include heating the first substrate 110 having the first inorganic layer 180 to bake the first inorganic layer 180.

FIGS. 4 and 5 are cross-sectional views illustrating a method of manufacturing the display substrate shown in FIG. 2.

FIGS. 4 and 5 are cross-sectional views illustrating exemplary embodiments of the present invention, a step of forming the first coating layer, and thus substantially the same members are represented by the same names and reference numerals.

FIG. 4 is a cross-sectional view illustrating a step of forming the first coating layer by a jetting method.

Referring to FIG. 4, the inorganic alignment layer 22 may be jetted in a direction of the first substrate 110 including the first pixel electrode PE1 by moving a printer 20 containing an inorganic alignment layer 22 which includes an organosilicon compound. Thus, a first coating laser 182 may be formed on the first substrate 110 including the first pixel electrode PE1.

In one embodiment, the first coating layer 182 may be formed by once jetting an inorganic alignment layer 22. In some embodiments the inorganic alignment layer 22 may be first jetted in one direction and may be second jetted in a different direction from the one direction, to form the first coating layer 182. The first coating layer 182 may be formed by jetting the inorganic alignment layer 22 and repeating the first jetting and the second jetting at least once.

FIG. 5 is a cross-sectional view illustrating a step of forming the first coating layer by a spin-coating method.

Referring to FIG. 5, an inorganic alignment layer 32 which includes an organosilicon compound may be dropped in an area of the first substrate 110 including the first pixel electrode PE1. The dropped inorganic alignment layer 32 may be entirely coated on the first substrate 110 including the first pixel electrode PE1 by using a spin coater (not shown) rotating in a vertical axis based on a surface of the first substrate 110.

Not shown in the figures, the first inorganic layer 180 may be formed by CVD process. For example, the silicon oxide is formed on an entire face of the first substrate 110 including the first pixel electrode PE1 to form the first inorganic layer 180.

Referring again to FIG. 2, in method of manufacturing the first opposite substrate 200, a transparent electrode layer (not shown) may be formed on the second substrate 210, and the transparent electrode layer may be patterned to the common electrode layer 220.

The second inorganic layer 230 may be formed on the second substrate 210 including the common electrode layer 220. The step of forming the second inorganic layer 230 may be substantially the same as the step of forming the first inorganic layer 180, except for the location forming the second inorganic layer 230. Thus, repetitive descriptions will be omitted.

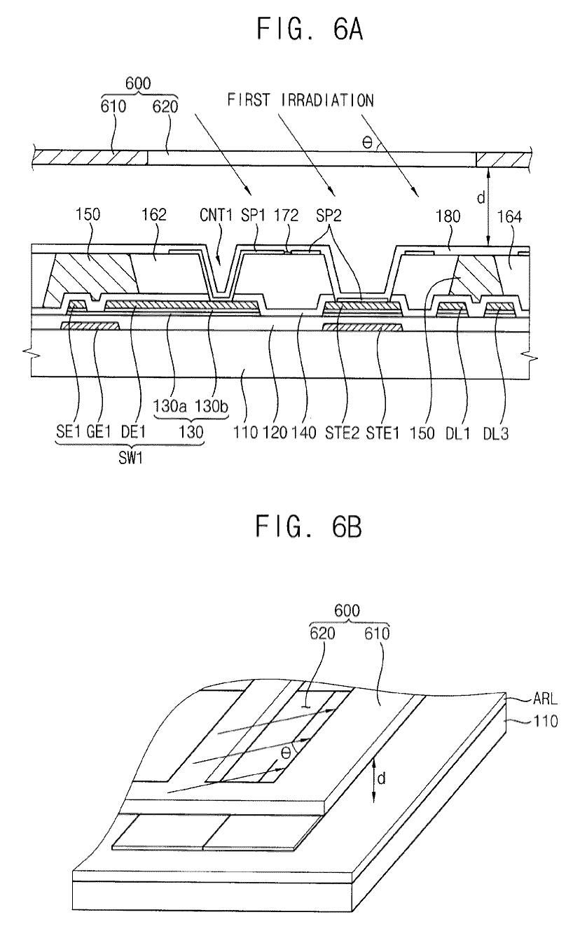

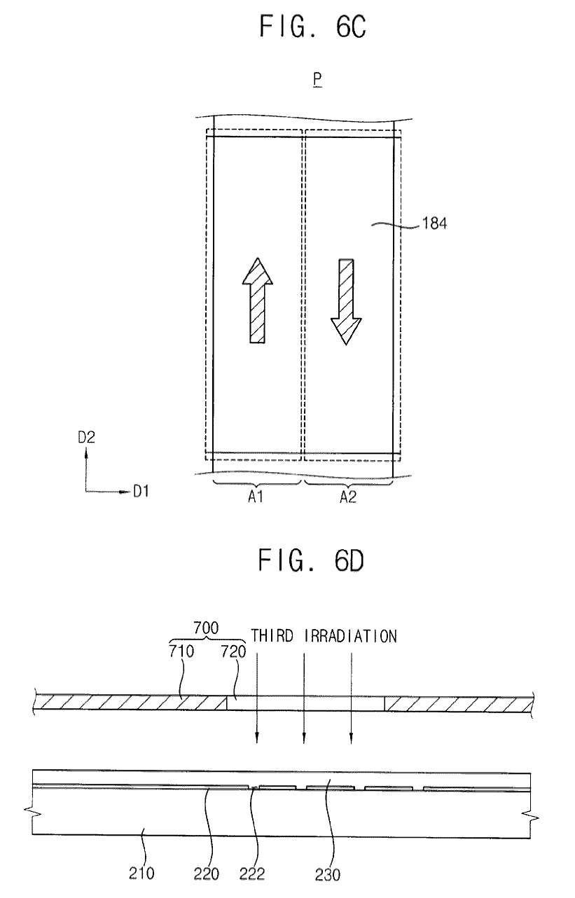

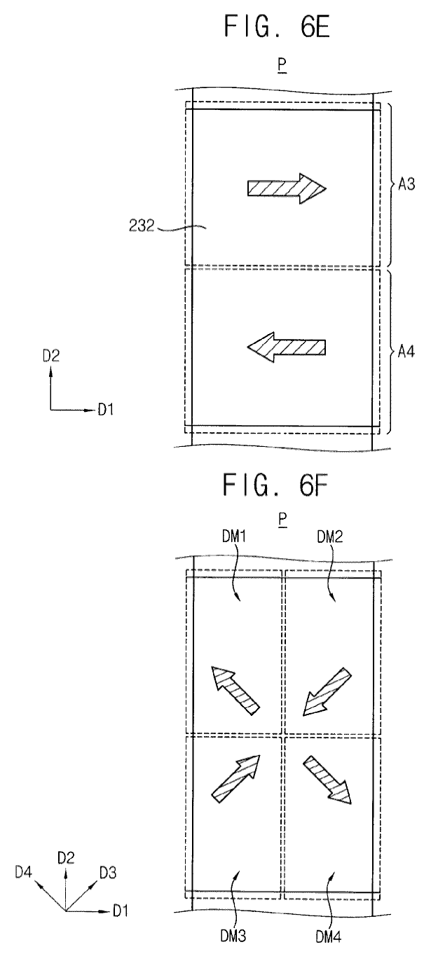

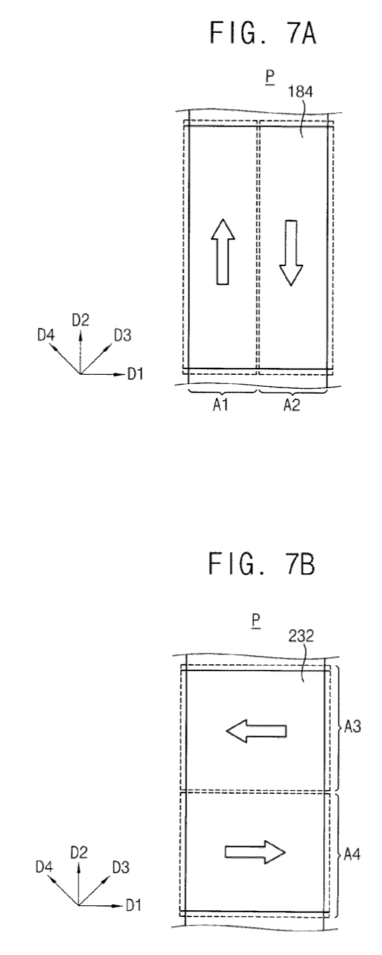

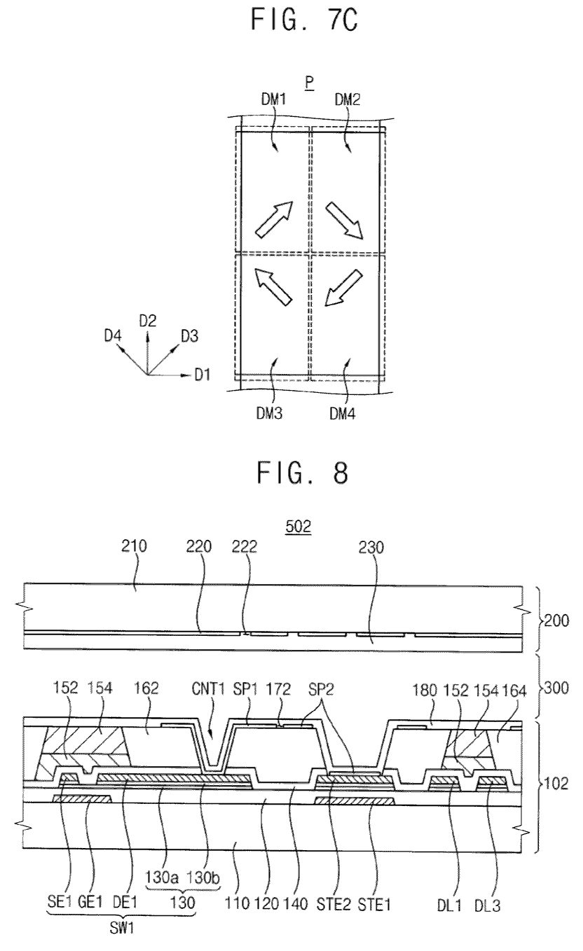

FIGS. 6A to 6F and 7A to 7C are cross-sectional, perspective and plan views illustrating a method of manufacturing a display device in accordance with an exemplary embodiment of the present invention.

FIGS. 6A to 6C are views illustrating a method of manufacturing a display substrate, and FIGS. 6D and 6E are views illustrating a method of manufacturing an opposite substrate. FIG. 7 is a plan view illustrating a display device in accordance with an exemplary embodiment of the present invention.

The display device in accordance with an exemplary embodiment may be substantially the same as the display device in accordance with the approach described above, except for forming the first alignment layer on the pixel electrode. Thus, repetitive descriptions will be omitted.

A method of manufacturing the display device in accordance with an exemplary embodiment further includes first and second irradiations of an ion beam in the method of manufacturing the display substrate and third and fourth irradiations of an ion beam in the method of manufacturing the opposite substrate. Thus, repetitive descriptions will be omitted.

Referring to FIG. 6A, a first mask 600 may be disposed on the first substrate 110 including a first inorganic layer 180. An ion beam may be first irradiated to the first inorganic layer 180.

A distance “d” between the first inorganic layer 180 and the first mask 600 may be determined to be less than or equal to about 200 μm. For example, the distance “d” may be in a range of about 50 μm to about 200 μm. For example, an angle (0) between the ion beam and a surface of the first mask 600 may be in a range of about 85° to about 88.9°.

An ion beam irradiating device for irradiating an ion beam (not shown) may form plasma by ionizing a provided gas to ions and electrons and accelerate the ions to emit a beam type. The provided gas may include argon (Ar), and the ion beam may include argon ions (Ar⁻). The energy of the ion beam may be in a range of about 50 eV to about 200 eV.

The first mask 600 may include a blocking portion 610 and an opening portion 620. The blocking portion 610 may block the ion beam from being irradiated to the first inorganic layer 180, and the opening portion 620 may pass the ion beam.

Referring to FIG. 6B, the first mask 600 may be disposed on the first substrate 110 including an array layer ARL. The array layer ARL may be defined by layers including the first inorganic layer 180 and layers lower than the first inorganic layer 180 shown in FIG. 6A. The highest layer in the array layer ARL may be the first inorganic layer 180.

The blocking portion 610 may be disposed in a first area A1 (see FIG. 6C) of the first inorganic layer 180 in the pixel P of the first substrate 110. The opening portion 620 may be disposed in a second area A2 (see FIG. 6(C) of the first inorganic layer 180 in the pixel P of the first substrate 110.

Referring to FIG. 6C, each of the first area A1 and the second area A2 may be defined as an area including a short side of the pixel P extending in a first direction D1 and a long side of the pixel P extending a second direction D2 perpendicular to the first direction D1. An area of the pixel P may be defined as the first area A1, and the second area A2 may be disposed at the first direction D1 of the first area A1.

The ion beam may be first irradiated to the first inorganic layer 180 over the first mask 600, and thus silicon oxide on a surface of the first inorganic layer 180 irradiating the ion beam may partially be ionized to be inclined at a predetermined angle based on the surface of the first substrate 110. For example, the predetermined angle may be in a range of about 80° to about 89.5°. A direction of a first irradiation of the ion beam for example, may be the second direction D2. Thus, silicon oxide on the surface of the first inorganic layer 180 in the first area A1 may be inclined at a predetermined angle in the second direction D2.

The first mask 600 may be moved in the first direction D1, and thus the opening portion 620 of the first mask 600 may be disposed in the second area A2. The first area A1 may correspond to the blocking portion 610 of the first mask 600. When the opening portion 620 may correspond to the second area A2, the ion beam may be second irradiated to the first inorganic layer 180. A direction of a second irradiation of the ion beam may be an opposite direction to the direction of the first irradiation of the ion beam. For example, the direction of a second irradiation of the ion beam may be an opposite direction to the second direction D2. Thus, silicon oxide on the surface of the first inorganic layer 180 in the second area A2 may be inclined at a predetermined angle in the opposite direction to the second direction D2.

The ion beam may be first and second irradiated to the first inorganic layer 180, that may extend in a direction perpendicular to the surface of the first substrate 110, to form a first alignment layer 184. Silicon oxide in the first area A1 of the first alignment layer 184 may be arranged in the second direction D2, and silicon oxide in the second area A2 of the first alignment layer 184 may be arranged in the opposite direction to the second direction D2.

Referring to FIG. 6D, a second mask 700 may be disposed on a second substrate 210 having a second inorganic layer 230. The ion beam may be third irradiated to the second inorganic layer 230 on the second mask 700. The second mask 700 may include a blocking portion 710 and an opening portion 720.

In FIG. 6D, although a direction or a third irradiation of the ion beam is illustrated a vertical direction based on a surface of the second substrate 210, an angle between the ion beam and a surface of the second mask 700 may be in a range of about 85° to about 88.9°.

Referring to FIG. 6E, the blocking portion 710 may be disposed in a third area A3 in a pixel P of the second substrate 210, and the opening portion 720 may be disposed in a fourth area A4 in the pixel P of the second substrate 210. The third area A3 may be an area of the pixel P, and the fourth area A4 may be a different area from the third area A3. The fourth area A4 may be disposed at the second direction D2 of the third area A3.

The ion beam may be third irradiated to the second inorganic layer 230 over the second mask 700, and then silicon oxide may be inclined at a predetermined angle based on the surface of the second substrate 210. For example, the predetermined angle may be in a range of about 80° to about 89.5°. A direction of the third irradiation of the ion beam, for example, may be the first direction D1. Thus, silicon oxide on the surface of the second inorganic layer 230 in the third area A3 may be inclined at a predetermined angle in the first direction D1.

The second mask 700 may be moved in the second direction D2, and thus the opening portion 720 of the second mask 700 may be disposed in the fourth area A4. The third area A3 may correspond to the blocking portion 710 of the second mask 700. When the opening portion 720 may correspond to the fourth area A4, the ion beam may be fourth irradiated to the second inorganic layer 230. A direction of a fourth irradiation of the ion beam may be an opposite direction to the direction of a third irradiation of the ion bean. For example, the direction of the fourth irradiation of the ion beam may be an opposite direction to the first direction D1. Thus, silicon oxide on the surface of the second inorganic layer 230 in the fourth area A4 may be inclined at a predetermined angle in the opposite direction to the first direction D1.

The ion beam may be third and fourth irradiated to the second inorganic layer 230 having verticality to form a second alignment layer 232. Silicon oxide in the third area A3 of the second alignment layer 232 may be arranged in the first direction D1, and silicon oxide in the fourth area A4 of the second alignment layer 232 may be arranged in the opposite direction to the first direction D1.

FIG. 6F is a view illustrating a plurality of domain areas of the display device in accordance with an exemplary embodiment,

Referring to FIG. 6F, the display device which is assembled using the display substrate including the first alignment layer 182 with the opposite substrate including the second alignment layer 232, may include a plurality of domain areas DM1, DM2, DM3 and DM4.

A first domain area DM1 may be an area formed by overlapping the first area A1 of the first substrate 110 with the third area A3 of the second substrate 210, and a second domain area A2 DM2 may an area formed by overlapping the second area A2 of the first substrate 110 with the third area A3 of the second substrate 210. A third domain area DM3 may be an area formed by overlapping the first area A1 of the First substrate 110 with the fourth area A4 of the second substrate 210, and a fourth area DM4 may be an area formed by overlapping the second area A2 of the first substrate 110 with the fourth area A4 of the second substrate 210.

An alignment direction of the third domain area DM3 is formed by the first alignment layer 184 and the second alignment layer 232. When the alignment direction is defined as a third direction D3 between the first and second directions D1 and D2, an alignment direction of the second domain area DM2 may be an opposite direction to the third direction D3. When an alignment direction of the first domain area DM1 is defined as a fourth direction D4, an alignment direction of the fourth domain area DM4 may be an opposite direction to the fourth direction D4.

As described above the ion beam is irradiated to the first inorganic layer 180 and the second inorganic layer 230, and thus the first alignment layer 184 and the second alignment layer 232 may be formed. In particular, the display device may include the first, second, third and fourth domain areas DM1, DM2, DM3 and DM4 defined by first, second, third and fourth irradiations of the ion beam, and thus viewing angle may be wider.

FIGS. 7A to 7C are plan views illustrating a plurality of domain areas of a display device including a first alignment latter aligned in the different direction in FIG. 6C and a second alignment layer aligned in the different direction in FIG. 6C.

FIG. 7A is a plan view of a display substrate, FIG. 7B is a plan view of an opposite substrate, and FIG. 7C is a plan view of a display device. In FIGS. 7A and 7B, the display substrate and the opposite substrate may be substantially the same display substrate and the same opposite substrate in FIGS. 6C and 6E, except for alignment directions of a first area A1, a second area A2, a third area A3 and a fourth area A4. In FIG. 7C, the display device may be substantially the same as the display device shown in FIG. 6F, except for alignment directions of a first domain area DM1, a second domain area DM2, a third domain area DM3 and a fourth domain area DM4. Thus, any repetitive descriptions will be omitted.

Referring to FIG. 7A, a first area A1 of a first alignment layer 184 may be arranged in a second direction D2, and a second area A2 of the first alignment layer 184 may be arranged in an opposite direction to the second direction D2. Referring to FIG. 7B, a third area A3 of a second alignment layer 232 may be arranged in an opposite direction to the first direction D1, and a fourth area A4 of the second alignment layer 232 may be arranged in the first direction D1.

Referring to FIG. 7C, thus, an alignment direction of a first domain area DM1 may be a third direction D3 between the first direction D1 and the second direction D2, and an alignment direction of a third domain area DM3 may be a fourth direction D4 between an opposite direction to the first direction D1 and the fourth direction D4. An alignment direction of a second domain area DM2 may be an opposite direction to the alignment direction of the third domain area DM3, and an alignment direction of the fourth domain area DM4 may be an opposite direction to the alignment direction of the first domain area domain DM1.

FIG. 8 is a cross-sectional view illustrating a display device in accordance with an exemplary embodiment of the present invention.

The display device in FIG. 8 may share one or more features with the display devices described in detail above with respect to the plan view of FIG. 1 and the cross-sectional views of FIGS. 2-5, except for a black matrix pattern visible in the cross-sectional views. Thus, repetitive descriptions will be omitted.

Referring to FIG. 8, a second display device 502 in accordance with an exemplary embodiment includes a second display substrate 102, a first opposite substrate 200 facing the second display substrate 102, and a liquid crystal layer 300 interposed between the second display substrate 102 and the first opposite substrate 200.

The second display substrate 102 may include a black matrix pattern 152 and 154 formed on a passivation layer 140. The black matrix pattern 152 and 154 may include a first blocking layer 152 which is formed on the passivation layer 140 and a second blocking layer 154 which is formed on the first blocking layer 152.

A protecting layer (not shown) may be formed on a boundary between the first blocking layer 152 and the passivation layer 140, between the second blocking layer 154 and the passivation layer 140, and between a first color filter 162 and the passivation layer 140. Mixing the black matrix pattern 152 and 154 and the first color filter 162 may be prevented by forming a protecting layer in the first color filter 162. The first color filter 162 may be easily attached with the first substrate 110 including the black matrix pattern 152 and 154.

A first inorganic layer 180 may be formed on the first substrate 110 including a first sub-electrode SP1 and a second sub-electrode SP2. Foreign materials generated from the first blocking layer 152, the second blocking layer 154 and the first color filter 162 may be prevented from flowing into the liquid crystal layer 300 by the first inorganic layer 180. The first inorganic layer 180 may extend in a direction perpendicular to the surface of the first substrate 110, and thus liquid crystal molecules of the liquid crystal layer 300 may be vertically aligned by the first inorganic layer 180.

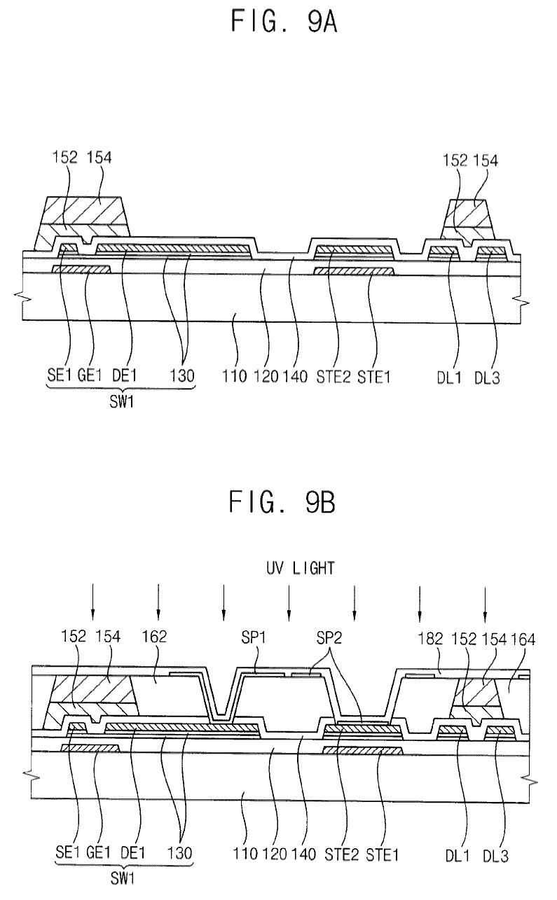

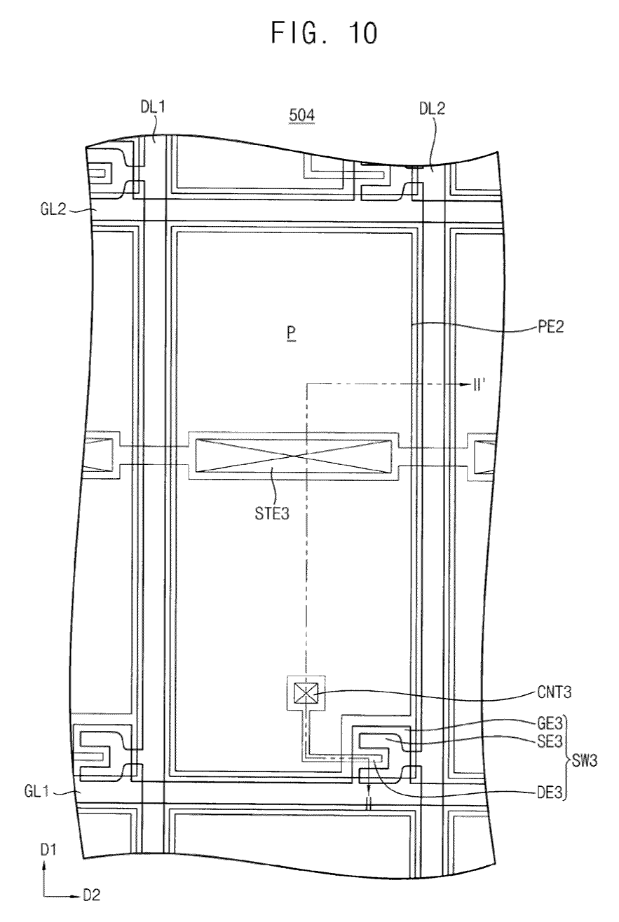

FIGS. 9A and 9B are cross-sectional views illustrating a method of manufacturing the display substrate shown in FIG. 8.

In FIG. 9A, steps of forming layer disposed under the passivation layer are substantially the same steps of forming layer disposed under the passivation layer. Thus, repetitive descriptions will be omitted.

Referring to FIG. 9A, the first blocking layer 152 may be formed on the first substrate 110 including the passivation layer 140. The first blocking layer 152 may be formed on a first TFT SW1, a first data line DL1 and a third data line DL3. For example, the first blocking layer 152 may be formed by a sputtering process. The first blocking layer 152 may be formed using a material reflecting a light and/or absorbing a light. For examples the first blocking layer 152 may be a single-layer structure including chromium (Cr) or a double-layer structure including a chromium layer and a chromium oxide layer (CrOₓ).

The second blocking layer 154 may be formed on the first substrate 110 including the first blocking layer 152. The second blocking layer 154 may include an organic material having a pigment. The pigment may represent black which reflects light and/or absorbs light. In some embodiments, the sum of a thickness of the first blocking layer 152 and a thickness of the second blocking layer 154 may be substantially the same as a thickness of the first color filter 162.

A surface of the first substrate 110 including the first blocking layer 152 and the second blocking layer 154 may be treated by a surface treatment process. In one embodiment, the surface treatment process may be performed by using an organic material having affinity with an organic ink. Thus, the protecting layer may be formed on the first substrate 110 including the first blocking layer 152 and the second blocking layer 154.

Referring to FIG. 9B, the first color filter 162 and the second color filter 164 may be formed on the first substrate 110 including the first blocking layer 152 and the second blocking layer 154. The first color filter 162 and the second color filter 164 may be formed by using the organic ink.

A first sub-electrode SP1 and a second sub-electrode SP2 may be formed on the first substrate 110 including the first color filter 162 and the second color filter 164. A first coating layer 182 may be formed on the first substrate 110 including the first sub-electrode SP1 and the second electrode SP2. Ultraviolet light may be irradiated to the first coating layer 182, and thus the first inorganic layer 180 may be formed on the first substrate 110 including the first and second sub-electrodes SP1 and SP2. The first coating layer 182 may be formed by a roller coating method, a spin-coating method, a jetting method or a dipping method under non-vacuum conditions.

A step of forming the first inorganic layer 180 may be substantially the same as the step of forming the first inorganic layer as described in detail above with respect to the plan view of FIG. 1 and the cross-sectional views of FIGS. 2-5. Thus, repetitive descriptions will be omitted.

An alignment layer may be formed by irradiating an ion beam to the first inorganic layer 180. A step of forming the alignment layer may be substantially the same as the step of forming the first alignment layer described in detail above with respect to FIGS. 6-7. Thus, repetitive descriptions will be omitted.

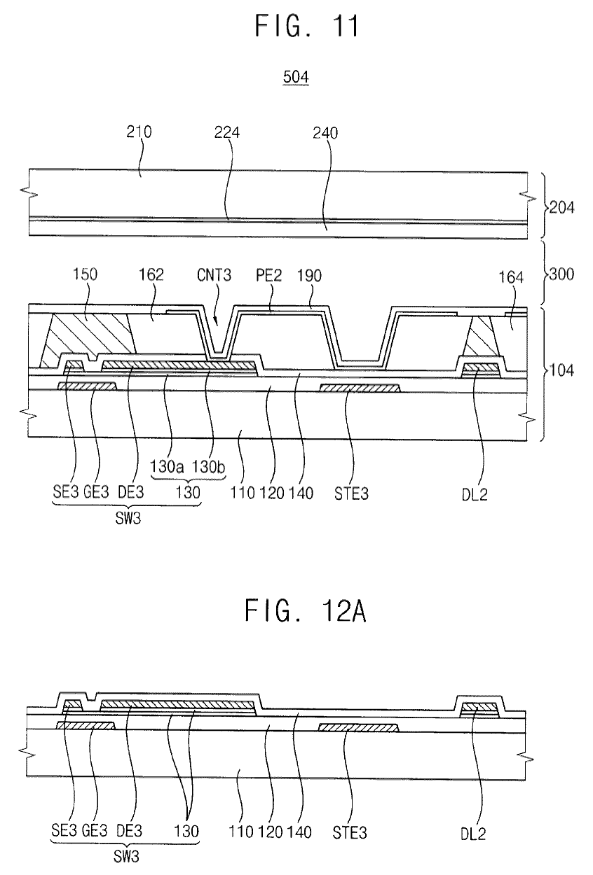

FIG. 10 is a plan view illustrating a display device in accordance with an exemplary embodiment of the present invention, and FIG. 11 is a cross-sectional view taken along a line II-II′ shown in FIG. 10.

Referring to FIGS. 10 and 11, a third display device 504 that includes a third display substrate 104, a second opposite substrate 204 facing the third display substrate 104, and a liquid crystal layer 300.

The third display substrate 104 may include a first gate line GL1, a second gate line GL2, a first data line DL1, a second data line DL2, a third TFT SW3, a third storage electrode STE3, a black matrix pattern 150, color filters 162 and 164, a second pixel electrode PE2 and a first alignment layer 190 which are formed on a first substrate 110.

The first gate line GL1 and the second gate line GL2 may cross the first data line DL1 and the second data line DL2 to define a pixel P of the first substrate 110.

The third TFT SW3 may include a third gate electrode GE3 connected to the first gate line GL1, a third source electrode SE3 connected to the second data line DL2, a third drain electrode DE3 spaced apart from the third source electrode SE3, and an active pattern 130.

The third storage electrode STE3 may be formed at the pixel P, and the third storage electrode STE3 may include a storage capacitor (Cst) with the second pixel electrode PE2. The storage capacitor (Cst) may include the third storage capacitor STE3, a gate insulation layer 120, a passivation layer 140 and the second pixel electrode PE2.

The second pixel electrode PE2 may be formed on the entire surface of the pixel P. The second pixel electrode PE2 may be formed on a first color filter 162 of color filters 162 and 164. The second pixel electrode PE2 may contact the third drain electrode DE3 through a third contact hole CNT3, and thus the second pixel electrode PE2 may be connected to the third TFT SW3.

The first alignment layer 119 may be slanted to have an inclination to a vertical direction based on a surface of the first substrate 110. For example, the tilt angle may be in a range of about 85° to about 89.5°. The first alignment layer 190 of a first area A1 (see FIG. 6C) may be slanted in a second direction D2, and the first alignment latter 190 of a second area A2 (see FIG. 6C) may be slanted in an opposite direction to the second direction D2. The first alignment layer 190 may block flowing impurities generated by the black matrix pattern 150 and the color filters 162 and 164 into the liquid crystal layer 300.

The second opposite substrate 204 may include a common electrode layer 224 and a second alignment layer 240 which are formed on a second substrate 210.

The common electrode layer 224 may be formed on the entire surface of the second substrate 210.

The second alignment layer 240 may be slanted to have a predetermined angle based on a surface of the second substrate 210. A third area A3 (see FIG. 6E) of the second alignment layer 240 may be arranged in a first direction D1, and a fourth area A4 (see FIG. 6E) of the second alignment layer 240 may be arranged in an opposite direction to the first direction D1.

The liquid crystal layer 300 may include negative type liquid crystal molecules having dielectric anisotropy having a negative value.

Although special patterns may not be formed in each of the second pixel electrode PE2 and the common electrode layer 224, the liquid crystal molecules may be interposed between the first alignment layer 190 and the second alignment layer 240, and thus the pixel P of the third display device may be divided to a plurality of domain areas (see FIG. 6F).

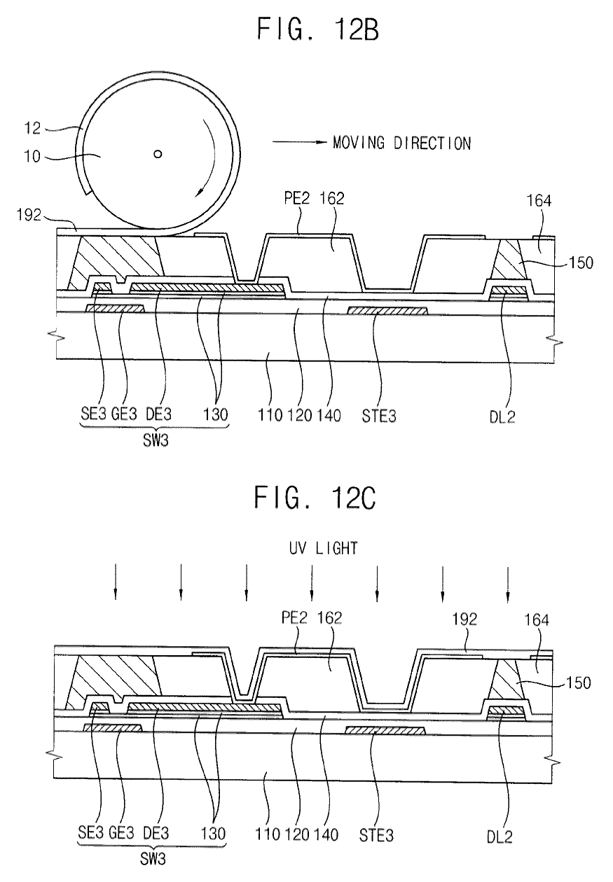

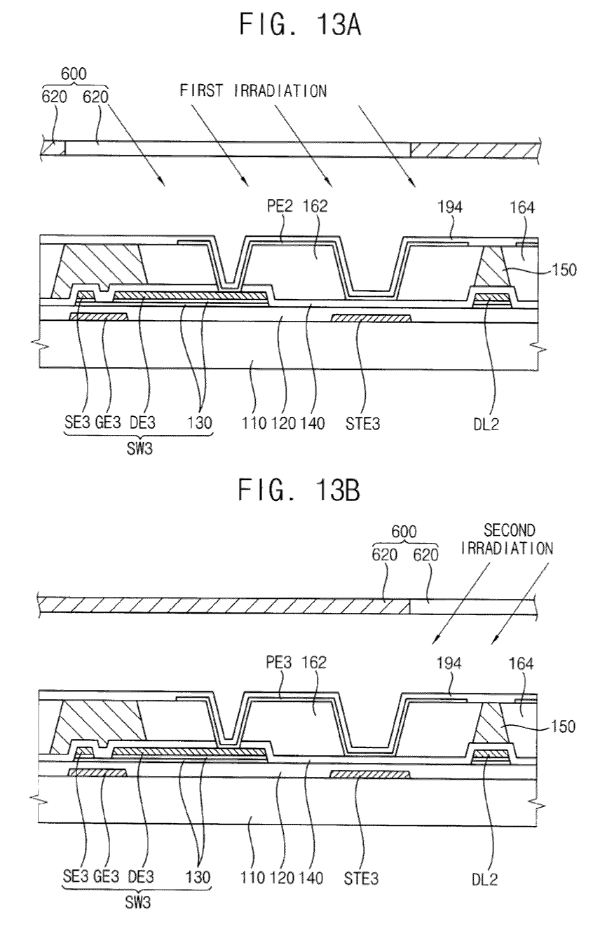

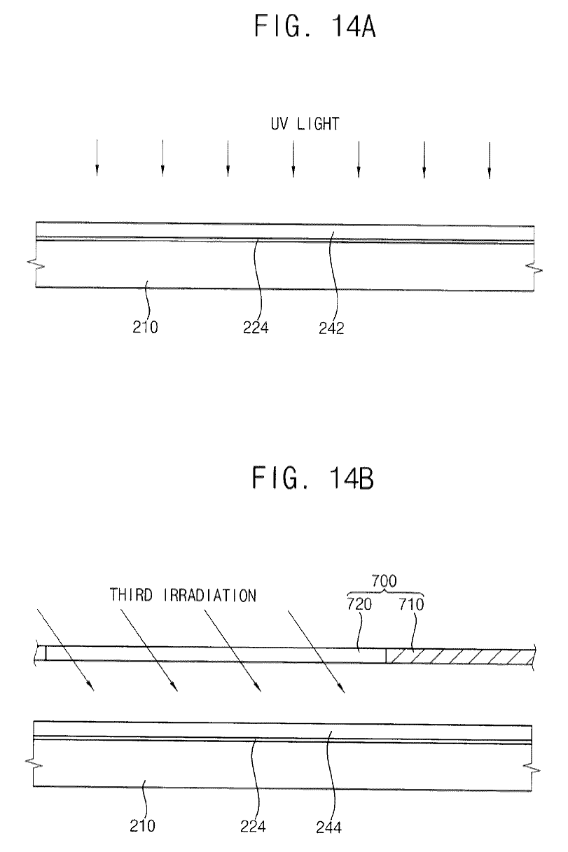

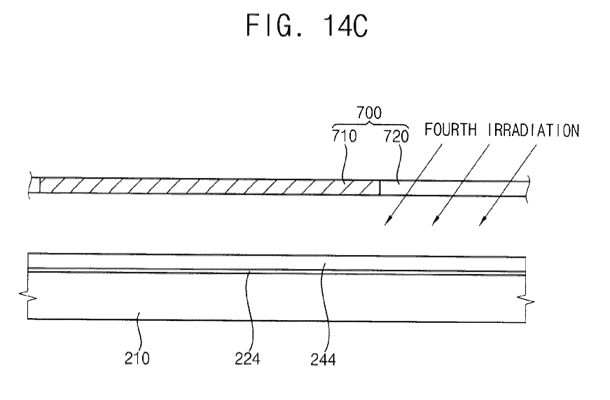

FIGS. 12A to 12C. FIGS. 13A and 13B, and FIGS. 14A to 14C are cross-sectional views illustrating a method of manufacturing the display substrate shows in FIG. 10.

Referring to FIG. 12A, a gate metal layer (not shown) may be formed on the first substrate 110. The gate metal layer may be patterned to form the third gate electrode GE3 and the third storage electrode STE3.

The gate insulation layer 120, a semiconductor layer 130a (see FIG. 11), an ohmic contact layer 130b (see FIG. 11) and a data metal layer (not shown) may be formed on the first substrate 110 including the third gate electrode GE3 and the third storage electrode STE3. The gate insulation layer 120, the semiconductor layer 130a, the ohmic contact layer and the data metal layer may be patterned to form the active pattern 130, the third source electrode SE3, the third drain electrode DE3 and the second data line DL2. The gate insulation layer 120 may be formed by a PECVD process under vacuum conditions.

The passivation layer 140 may be formed on the first substrate 110 including the third source electrode SE3, the third drain electrode DE3 and the second data line DL2. The passivation layer 140 may be formed by a PECVD process under vacuum conditions.

Referring to FIG. 12B, the black matrix pattern 150 may be formed on the first substrate 110 including the passivation layer 140. The first and second color filters 162 and 164 man be formed on the first substrate 110 including the black matrix pattern 150. A transparent electrode layer (not shown) may be formed on the first substrate 110 having the first and second color filters 162 and 164, and the transparent electrode layer may be patterned to form the second electrode PE2.

A first coating layer 192 may be formed on the first substrate 110 including the second pixel electrode PE2. The first coating layer 192 may be formed by rolling an inorganic alignment layer on the second pixel electrode PE2 using a roller. The inorganic alignment layer may include polydimethylsiloxane (PDMS).

A step of forming the first coating layer 192 may be substantially the same as the step of forming first coating layer as described in detail above with respect to the plan view of FIG. 1 and the cross-sectional views of FIGS. 2-5. Thus, any repetitive descriptions will be omitted.

In some embodiments, the first coating layer 192 may be formed by a spin-coating method, a jetting method or a dipping method using the inorganic alignment layer.

Referring to FIG. 12C, UV light may be irradiated to the first coating layer 192. Oxygen may be further provided for the first coating layer 192. The inorganic alignment layer of the first coating layer 192 may react in the UV light to form silicon oxide.

In some embodiments, the inorganic alignment layer may include a compound of a sol state and a solvent dispersing the compound. The inorganic alignment layer including the compound may be coated on the first substrate 110 including the second pixel electrode PE2 by a roller coating method, a spin-coating method or a jetting method, and thus the first coating layer may be formed. Removing the solvent of the inorganic alignment layer, the compound may form silicon oxide of gel state through a hydrolysis and/or a condensation reaction.

Referring to FIG. 13A, a first mask 600 may be disposed on the first substrate 110 including the first inorganic layer 114 having silicon oxide. An ion beam may be first irradiated to the first inorganic layer 194 on the first mask 600. Thus, the first inorganic layer 194 in a first portion A1 (see FIG. 6C) of the first substrate 110 may be arranged in a particular direction.

Silicon oxide of the first inorganic layer 194 in the first area A1 may be ionized to be slanted in the particular direction, and thus the first inorganic layer 194 in the first portion A1 may be arranged in the particular direction. For example, the particular direction may be the second direction D2 of the first substrate 110.

Referring to FIG. 13B, the first mask 600 may be moved in the first direction D1. The ion beam may be second irradiated to a second area A2 (see FIG. 6C) of the first inorganic layer 194. Silicon oxide of the first inorganic layer 194 in the second area A2 may be arranged in a different direction from the particular direction. For example, the first inorganic layer 194 in the second area A2 may be arranged in an opposite direction to the second direction D2. Thus, the first alignment layer 190 may be formed on the first substrate 110 including the second pixel electrode PE2.

Referring to FIG. 14A, a second coating layer 242 may be formed on the second substrate 210 including the common electrode layer 224. A step of forming the second coating layer 242 may be substantially the same as the step of forming the first coating layer 192. Thus, any repetitive descriptions will be omitted.

UV light may be irradiated to the second coating layer 192. The inorganic alignment layer of the second coating layer 192 may react in the UV light to form silicon oxide.

In some embodiments, a step of irradiating the UV light may be omitted when silicon oxide may be formed by a sol-gel process.

Referring to FIG. 14B, a second mask 700 may be disposed on the second substrate 210 including a second inorganic layer 244 including silicon oxide. An ion beam may be third irradiated to the inorganic layer 244 on the second mask 700. Thus, the second inorganic layer 244 in a third area A3 (see FIG. 6E) of the second substrate 210 may be arranged in a particular direction. The particular direction may be a first direction D1.

Referring to FIG. 14C, the second mask 700 may be moved in the second direction D2. The ion beam may be fourth irradiated to a fourth area A4 (see FIG. 6E) of the second inorganic layer 244. Silicon oxide of the second inorganic layer 244 in the fourth area A4 may be arranged in an opposite direction from the first direction D1. Thus, the second alignment layer 240 may be formed on the second substrate 210 including the common electrode layer 224.

Previously described above, although special patterns may not be formed in each of the second pixel electrode PE2 and the common electrode layer 224, the liquid crystal molecules may be interposed between the first alignment layer 190 and the second alignment layer 240, and thus the pixel P of the third display device may be divided to a plurality of domain areas (see FIG. 6F). A viewing angle may be wider, and process of manufacturing the display device may be simplified by being omitted a step of patterning the common electrode layer 224. Thus, the display quality and the productivity may be improved.

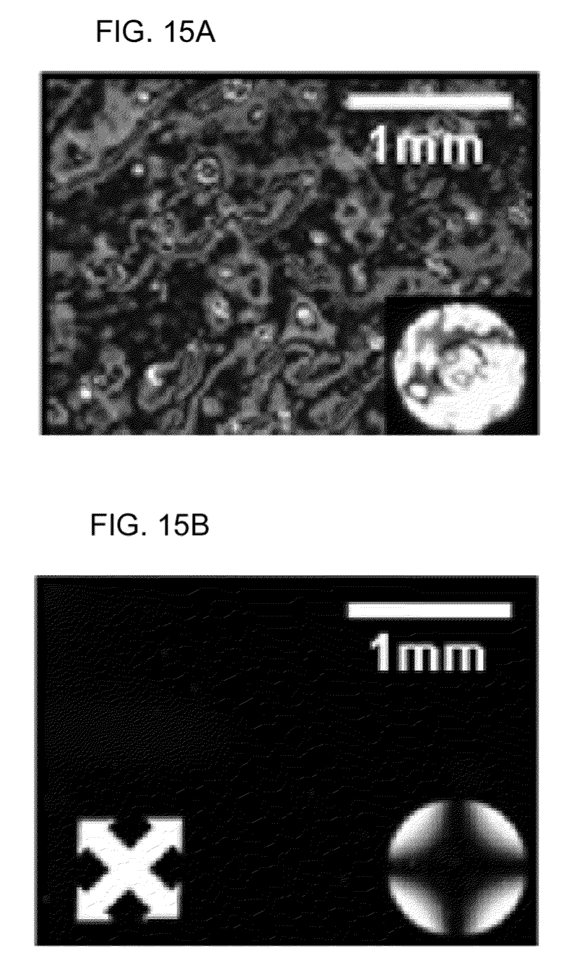

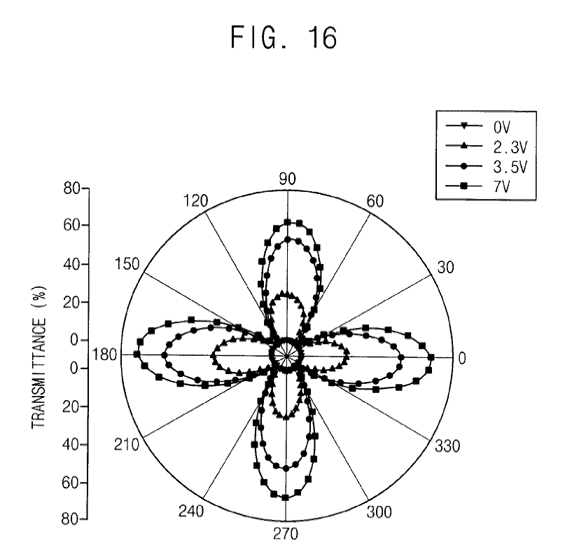

FIG. 15A is an image showing a polarized optical microscope image of a coating layer in accordance with an exemplary embodiment of the present invention.

Referring to FIG. 15A, an inorganic alignment layer of the coating layer is randomly formed on a substrate. Straight polarized lights perpendicular to each other are bent by the coating laster to pass through different paths from each other, and thus stains mass be displayed.

FIG. 15B is an image shoving a polarized optical microscope image of an inorganic layer in accordance with an exemplary embodiment of the present invention.

Referring to FIG. 15B, the inorganic layer includes silicon oxide that extends in a direction perpendicular to a surface of the second substrate 210, and a polarized light perpendicular to the surface of the second substrate 210 does not pass through the inorganic layer. Thus, the polarized light may not display an image except for black.

FIG. 16 is a graph illustrating transmittance according to a driving voltage and which represents alignment characteristics of the inorganic layer in accordance with an exemplary embodiment of the present invention.

Referring to FIG. 16, an inorganic alignment layer is formed on a substrate, and an ion beam is irradiated to the inorganic alignment layer to form an inorganic layer including silicon oxide. When a voltage of a liquid crystal layer in a display panel including the inorganic layer is about 0 V, the transmittance of the display panel is about 0%. When a voltage of the liquid crystal layer is about 2.3 V, the transmittance of the display panel is about 20%. When a voltage of the liquid crystal layer is about 3.5 V, the transmittance of the display panel is about 50%. When a voltage of the liquid crystal layer is about 7.0 V, the transmittance of the display panel is about 63%. Thus, the inorganic layer typically has characteristics of a vertical alignment layer.

In accordance with one or more exemplary embodiments of the present disclosure, an inorganic layer extending in a direction perpendicular to the surface of a substrate is formed on a color filter, and thus impurities generated from the color filter may be prevented form flowing into a liquid crystal layer. Thus, the display quality may be increased.

Moreover, a capping layer blocking the impurities may be omitted by forming the inorganic layer, and thus manufacturing costs may be decreased and the productivity may be increased. In particular, a step of forming the inorganic layer may be easily performed by a coating process in non-vacuum conditions without using an expensive apparatus maintaining vacuum conditions, and thus the productivity may be increased.

The foregoing is illustrative of exemplary embodiments of the present invention and is not to be construed as limiting. Although exemplary embodiments of the present invention have been described, those skilled in the art will readily appreciate that many modifications are possible without materially departing from the present invention.

What is claimed is:

1. A method of manufacturing a display substrate, the method comprising:
forming a color filter on a first substrate including a switching element;
forming a pixel electrode on the first substrate including the color filter, the pixel electrode connected to the switching element; and
forming an inorganic alignment layer on the first substrate including the pixel electrode, the inorganic alignment layer including an inorganic compound.

2. The method of claim 1, wherein forming the inorganic alignment layer comprises:
forming a coating layer by spreading the inorganic alignment layer; and
forming an inorganic layer on the first substrate including the pixel electrode using the coating layer.

3. The method of claim 2, further comprising:
forming a black matrix pattern on the switching element of the first substrate.

4. The method of claim 3, wherein the color filter is overlapped with an adjacent color filter which is in an area corresponding to a boundary between the pixel electrode and an adjacent pixel electrode adjacent to the pixel electrode.

5. The method of claim 2, wherein forming the inorganic layer comprises exposing the inorganic alignment layer of the coating layer to UV light to arrange the inorganic compound at a surface of the inorganic layer.

6. The method of claim 2, wherein forming the coating layer comprises rolling the inorganic alignment layer using a roller.

7. The method of claim 2, wherein forming the coating layer comprises:
dropping the inorganic alignment layer on the First substrate including the pixel electrode; and
spin-coating the dropped inorganic alignment layer.

8. The method of claim 2, wherein the inorganic layer extends in a direction perpendicular to a surface of the first substrate.

9. The method of claim 2, wherein the inorganic compound comprises an organosilicon compound, and the inorganic layer comprises silicon oxide (SiOₓ, 0<x≦1).

10. The method of claim 9, wherein the organosilicon compound comprises polo dimethylsiloxane (PDMS).

11. The method of claim 9, wherein the organosilicon compound comprises tetraethoxysilane (TEOS) or methyl triethoxysilane (MTES).

12. The method of claim 2, wherein forming the inorganic alignment layer further comprises exposing the inorganic layer to an ion beam to form an alignment layer including the inorganic compound, the alignment layer aligning liquid crystal molecules to a pretilt angle.

13. The method of claim 12, wherein forming the alignment layer comprises:
exposing the inorganic layer to the ion beam with a first direction in a first area of a pixel area of the first substrate including the pixel electrode; and
subsequently the inorganic layer to the ion beam with a second direction, opposite to the first direction, in a second area of the pixel area.

14. The method of claim 1, wherein the inorganic alignment layer is formed by chemical vapor deposition (CVD) process.

15. A method of manufacturing a display device, the method comprising:
coating an inorganic alignment layer including an inorganic compound on a first substrate to form a display substrate including a first inorganic layer, the first substrate including a switching element, a color filter and a pixel electrode;
coating an inorganic alignment layer on a second substrate facing the first substrate to form an opposite substrate including a second inorganic layer; and
assembling the display substrate and the opposite substrate to manufacture the display device.

16. The method of claim 15, wherein forming the first inorganic layer comprises:
coating the inorganic alignment layer using a roller coating method, a spin-coating method, a jetting method or a dipping method, and
forming the second inorganic layer comprises:
coating the inorganic alignment layer using a roller coating method, a spin-coating method, a jetting method or a dipping method.

17. The method of claim 16, wherein forming the first inorganic layer further comprises exposing a first coating layer to UV light, the first coating later formed by coating the inorganic alignment layer on the first substrate,
and wherein forming the second inorganic layer further comprises exposing a second coating layer to UV light, the second coating layer formed by coating the inorganic alignment layer on the second substrate.

18. The method of claim 16, wherein the inorganic compound comprises organosilicon compound, and each of the first inorganic layer and the second inorganic layer comprises silicon oxide (SiOₓ, 0<x≦1).

19. The method of claim 15, further comprising:
exposing the first inorganic layer to an ion beam to form a first alignment layer; and
exposing the second inorganic layer to the ion beam to form a second alignment layer.

20. The method of claim 19, wherein forming the first alignment layer comprises:
exposing the first inorganic layer to the ion beam in a first area of the first substrate, while the ion beam is angled at a first direction; and
subsequently exposing the inorganic layer to the ion bean in a second area of the first substrate, the second area being different from the first area, while the ion beam is angled at a direction opposite to the first direction.

21. The method of claim 20, wherein forming the second alignment layer comprises:
exposing the second inorganic layer to the ion bean in a third area of the second substrate, while the ion beam is angled in a second direction that is different from the first direction and different from the direction opposite to the first direction; and
exposing the second inorganic layer to the ion beam in a fourth area of the second substrate, the third area being different from the third area, while the ion beam is angled in a direction opposite to the second direction.

22. The method of claim 14, further comprising:
interposing a plurality of liquid crystal molecules having a negative dielectric anisotropy between the display substrate and the opposite substrate.

23. The method of claim 15, wherein each of the first and the inorganic layers is formed by chemical vapor deposition process.

24. A display substrate comprising:
a switching element formed on a first substrate;
a color filter formed on the first substrate including the switching element;
a pixel electrode formed on the color filter and connected to the pixel electrode; and
an inorganic layer formed on the first substrate including the pixel electrode.

25. The display substrate of claim 24, wherein the inorganic layer comprises silicon oxide (SiOₓ, 0<x≦1).

26. The display substrate of claim 24, further comprising:
a black matrix pattern formed in an area corresponding to the switching element of the first substrate.

27. The display substrate of claim 24, wherein the color filter is overlapped with an adjacent color filter in an area corresponding to a boundary between the pixel electrode and an adjacent pixel electrode adjacent to the pixel electrode.

28. A display device comprising:
a switching element formed on a first substrate;
a color filter formed on the first substrate including the switching element;
a pixel electrode formed on the color filter and connected to the switching element: and
an alignment layer formed on the pixel electrode, the alignment layer including an inorganic compound, the alignment layer aligning liquid crystal molecules to a pretilt angle.

29. The display device of claim 28, wherein the alignment layer comprises silicon oxide (SiOₓ, 0<x≦1).

30. The display device of claim 28, wherein the inorganic compound of the alignment layer, which is formed in a first area of the pixel electrode, is arranged in a first direction, and the inorganic compound of the alignment layer, which is formed in a second area of the pixel electrode different from the first area, is arranged in a second direction opposite to the first direction.

31. The display device of claim 28, further comprising a black matrix pattern formed in an area corresponding to the switching element of the first substrate.

32. The display device of claim 28, wherein the color filter is overlapped with an adjacent color filter in an area corresponding to a boundary between the pixel electrode and an adjacent pixel electrode adjacent to the pixel electrode.
